(19) United States
(12) Patent Application Publication
(10) Pub. No.: US 2002/0108499 A1
(43) Pub. Date: Aug. 15, 2002

(54) Adapter to a lid assembly for adapting the lid assembly to different types of coffee makers

(76) Inventor: Raymond Chin-Wen Lin, West Covina, CA (US)

Correspondence Address: Bo-In Lin, 13445 Mandoli Drive, Los Altos Hills, CA, 94022, US

(21) Appl. No.: 09/782,758

(22) Filed: Feb. 12, 2001

(51) Int. Cl. A47J 31/00

(52) U.S. Cl. 99/323.3; 99/275

(57) ABSTRACT

The present invention discloses decanter for operating with at least two types of coffee makers. The decanter includes a base-lid for mounting on the decanter for brewing coffee with a first type of coffee makers. The decanter further has a lid-attachment for attaching to the base-lid to constitute a combined lid assembly for mounting on and covering the decanter suitable for brewing coffee with a second type of coffee makers. In a preferred embodiment, the base-lid further includes receptive adapting slots for receiving and removably adapting the lid attachment to the base-lid whereby the lid-attachment may be flexible attached and removed from the base-lid.

### BACKGROUND OF THE INVENTION

1. Field of the Invention

This invention relates generally to lid assemblies for drip-type automatic coffee makers having anti-drip valve mechanisms. More particularly, this invention relates to a new and improved lid-assembly that includes conversion-adapter for converting a lid assembly suitable for one type of coffee maker to different type of coffee makers.

2. Description of the Prior Art

A user of a drip-type automatic coffee maker having anti-drip valve mechanisms is often faced with a limitation that in order to properly operate the coffee maker a specific coffee maker lid-assembly must be used. The limitation arises from a coffee maker configuration that many automatic drip-type coffee makers include an anti-drip valve arrangement located at the outflow opening of the coffee maker's filter/brew funnel. These valve arrangements prevent coffee from continually flowing or dripping out of the filter/brew funnel when the coffee maker's decanter or carafe is removed from the coffee maker. This may often occur that a user wising to pour partially brewed coffee during the brewing cycle without waiting for the completion of brewing cycle of the coffee maker. As such user remove the decanter from the coffee maker during the brewing cycle the anti-drip valve will be closed by an automatic anti-drip mechanism to prevent further dripping of the coffee from the filter/brew funnel. Meanwhile, the brewing water builds up within in the filter/brew funnel, and is released when the decanter is returned to the coffee maker to automatically open the anti-drip valve.

Conventionally, each coffee maker provided with the anti-drip valve is generally arranged to operate with particular decanters covered with specially made lid assembly. The anti-drip valve typically includes a spring-biased lever. As the carafe covered with the lid-assembly is placed in the coffee maker, the spring biased lever or arm is engaged by a top surface of a lid assembly. Then, the spring-biased lever is pushed upward to open the anti-drip valve. The lid assembly further includes a central opening for directly dripping the brewed coffee from the filter/brew funnel into the decanter. As the decanters manufactured by each coffee maker come with specific shapes, sizes and distinctive designs, the lid-assemblies are must also manufactured with corresponding shapes and sizes to match the decanter for operating with the automatic coffee maker for enabling the anti-drip valve opening functions. For these reasons, the lid-assembly for a coffee decanter for an anti-drip automatic coffee maker is manufactured very specifically as a unique part to operate only with certain types of coffee maker used with particular types of decanters. Such limitation of using one specific lid-assembly for limited types of decanters for particular brand of coffee makers often increases the manufacture and inventory costs for the coffee makers and suppliers.

In an issued U.S. Pat. No. 5,150,803, entitled “Decanter and Lid Assembly for Automatic Drip Coffee Maker”, Cartellone discloses a lid assembly for a decanter for use with an automatic drip-type coffee maker. The lid assembly is adjustable so as to vary the overall height of the decanter and lid assembly. Cartellone is able to achieve the adjustment of the height by providing the decanter with a mounting sleeve. The sleeve is attachable to the open upper end of the decanter. Cartellone then provides a lid that has a dimension for attachment to the mounting sleeve. The sleeve further includes an opening extending through the top opening of the decanter and communicating with the interior of the decanter, and at least one column of vertically-aligned, horizontally oriented slots. Each of the slots has a side communicating with the opening through the sleeve. A recess is formed in the sleeve adjacent the column of slots, the recess being in communication with the opening through the sleeve and communicating with each of the slots. The lid has a dimension to engage within the opening of the sleeve and be rotatable within the sleeve. The lid has at least one outwardly extending, generally horizontal lug that has a dimension move within the recess in the sleeve movable from the recess into one of the horizontally oriented slots when the lid is rotated.

With the height adjustable feature as discussed above, Cartellone is able to resolve the problem that when the decanter is broken, the user is able to replace the decanter with a “like kind”. By making use of the height adjustable sleeve and lid on a decanter of like kind that can be mounted with the specific sleeve, a user may still fully utilize the features of the coffee maker without require to purchase another identical decanter. Cartellone however, does not resolve the limitation that a like kind decanter must be used for the specific types of sleeve and lid. A coffee maker user is limited to use a decanter of “like-kinds” that are generally produced by the same-coffee maker manufacturer. Due to the facts that the lid assemblies are not exchangeable between coffee makers manufactured by different companies, Caartellone's invention, even useful for certain coffee maker users, cannot resolve the difficulties of additional inventory and costs faced by the coffee maker suppliers. This is particularly true for the suppliers or wholesalers deal with more than one brands of coffee makers.

Therefore, a need still exists in the art of coffee maker industry to provide a solution for coffee maker manufacturers and suppliers to have some common parts that can be useful for coffee makers of different brands. Specifically, it is desirable one of such common parts can be used directly on one types of coffee makers directly. Additional accessories can be conveniently adapted to the common lid for converting the lid for use in at least a different brand.

### SUMMARY OF THE PRESENT INVENTION

It is therefore an object of the present invention to provide a lid-attachment for removably attaching to a base-lid. The lid-attachment is employed to convert a the base lid from originally being used on a fist anti-drip coffee maker to become a converted lid-assembly for use with a second type of anti-drip coffee maker. The base-lid that is originally made for the first type of coffee maker has a lower height. As the lid-attachment attached to the base-lid, the combined lid-assembly has a greater height and become compatible to operate with a second types of coffee makers.

Another object of this invention is to provide a new and improved lid-assembly to enable a decanter to operate with different types of coffee makers. By mounting different types of lid-attachment over a base-lid, the base-lid is converted to a second combined lid assembly suitable for operating with a different type of coffee makers.

Another object of this invention is to provide a decanter and lid assembly suitable for use in automatic drip-type coffee makers with simple operations by attaching a lid attachment. The height of the decanter and lid can be easily changed by attaching the lid-attachment or simply by removing the lid attachment.

Another object of this invention is to provide a decanter and lid assembly wherein the lid assembly has an upper surface dimensioned to operatively engage the control lever for several kinds of anti-drip valve arrangements used on automatic drip-type coffee makers

Another object of this invention is to provide a decanter and lid assembly wherein the lid assembly is easily secured to a carafe or decanter and where adjustment of height can be easily accomplished by attaching a lid attachment. The lid assembly as disclosed in this invention is simple, economical and easy to use.

Briefly, in a preferred embodiment, the present invention discloses a a coffee lid-assembly. The coffee lid-assembly includes a base-lid suitable for employing with a first type of coffee makers. The lid-assembly further includes a lid-attachment, e.g., a lid-cap, for attaching to the base-lid to constitute a combined lid assembly suitable for employing with a second type of coffee makers. In a preferred embodiment, the base-lid further had receptive adapting means for receiving and removably adapting the lid attachment to the base-lid whereby the lid-attachment may be flexible attached and removed from the base-lid. In another preferred embodiment, the receptive adapting means for receiving and removably adapting the lid attachment further includes several elongated slots. And, the lid attachment further comprising fingers each having a bent hook for inserting into one of the slots to move along in the slots and hook onto the base-lid. In another preferred embodiment, the base-lid further includes a first drip opening for dripping brewed coffee brewed by the first type of coffee makers therethrough. In another preferred embodiment, the base-lid further includes a first valve opening means for engaging and opening a first-type anti-drip valve of the first type of coffee makers for dripping the brewed coffee through the first drip opening. In a preferred embodiment, the lid attachment further includes a second drip opening for dripping brewed coffee brewed by the second-type of coffee makers therethrough. And, the lid-attachment further includes a second valve opening means for engaging and opening a second-type anti-drip valve of the second type of coffee makers for dripping the brewed coffee through the second drip opening.

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

FIGS. 1A to 1C are respectively top view, side cross sectional view and bottom view of a base-lid for a coffee decanter employed on a first type of coffee maker of this invention;

FIGS. 2A to 2D are respectively top view, side view, bottom view and side cross sectional view of a lid-attachment of this invention; and

FIGS. 3A to 3C are respectively top view, side view and side cross sectional view a combined-lid for a coffee decanter employed on a second type of coffee maker of this invention.

### DETAILED DESCRIPTION OF THE PREFERRED EMBODIMENT

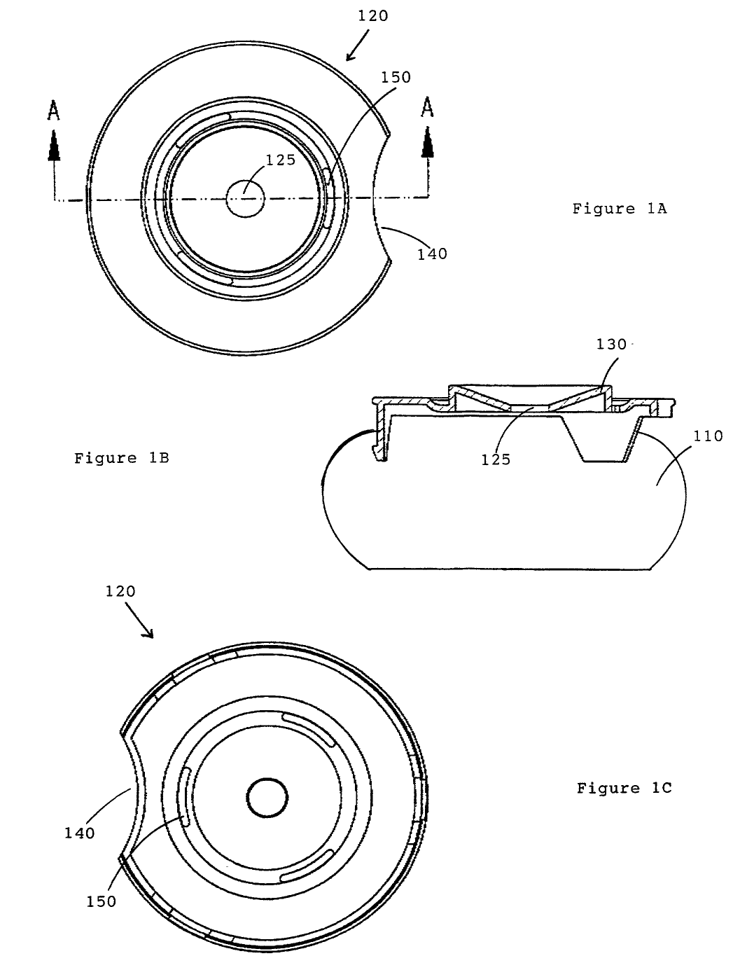

Referring now to the drawings wherein the showings are for the purpose of illustrating a preferred embodiment of the invention. These embodiments are provided only for the purpose of describing the invention and should not in anyway limiting the scopes of the invention as defined by the appended claims. FIGS. 1A to 1C are respectively a top view, a side cross sectional view and a bottom view of a base-lid 120 of this invention for covering a coffee decanter 110 suitable for brewing coffee and dripping coffee from a through-hole 125 on a first type of anti-drip coffee makers. The base-lid 120 includes an anti-drip valve opening mechanism 130 formed as an elevated terrace on top of the base-lid 120. The valve-opening mechanism when mounted on the decanter 110 and placed in an anti-drip coffee maker, engages and pushes the anti-drip-valve to a open position for dripping the brewed coffee from the through hole 125 into the decanter 110. The base-lid is formed substantially as a circular lid having a cutoff section 140 for pouring coffee out from the decanter 110. The base-lid further has elongated slots 150 as receptive adapting openings for receiving a lid-attachment, e.g., a lid-cap, as will be further described below.

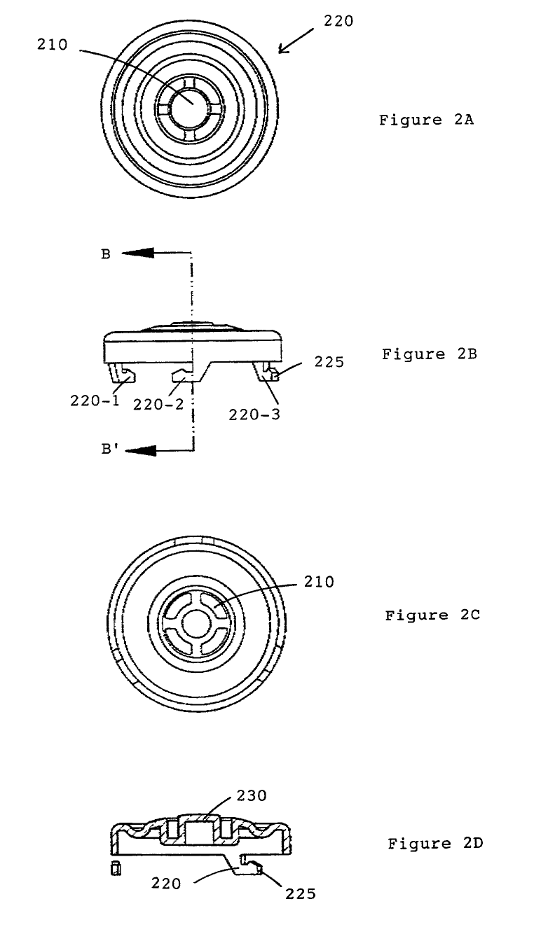

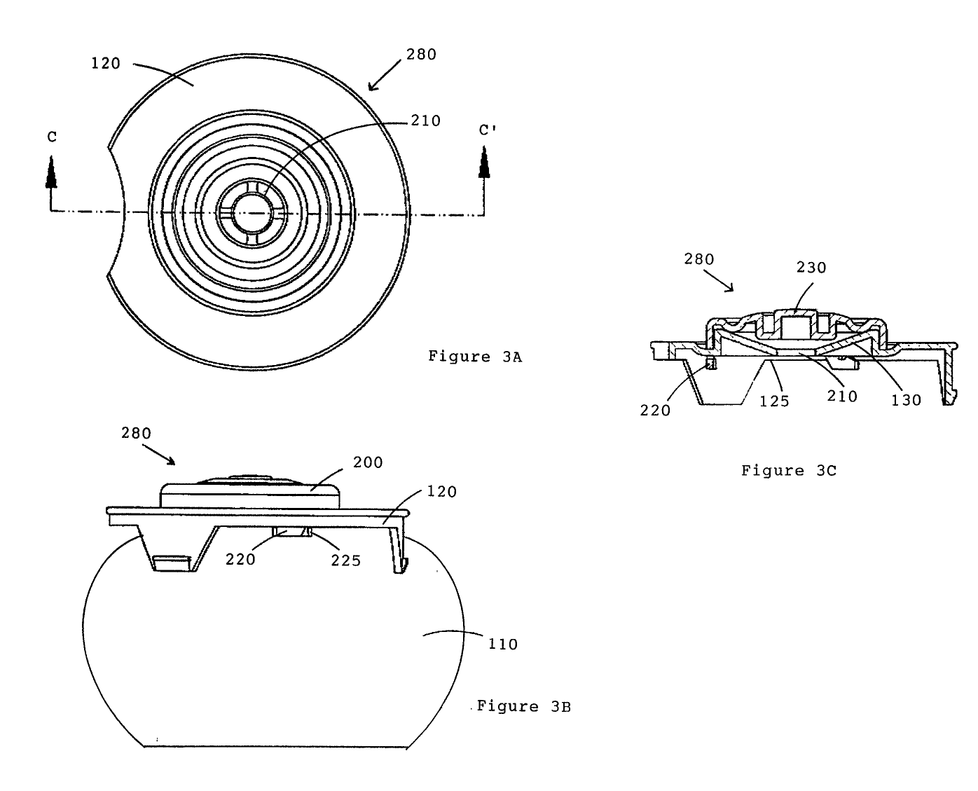

FIGS. 2A to 2D shows respectively a top view, a side view, a bottom view and a side-cross sectional view along a cutoff cross section along B-B′ of FIG. 2B for an attachment lid 200 of this invention. The lid-attachment 200 has a drip-opening 210 for dripping brewed coffee into a coffee decanter 110 when operated with a second type of coffee maker to be further described in FIG. 3 below. The lid attachment 200 is formed with several locking fingers, e.g., three locking fingers 220-1, 220-2, and 220-3 for inserting into the elongated slots 150. Each of these locking fingers further has a bent hook 225 for locking onto edges of the slots 150. The lid-attachment further has a valve opening mechanism 230 formed as elevated cap surrounding the drip opening 210. The valve-opening mechanism 230 when mounted on base-lid and covering the decanter 110 and placed in a second type of anti-drip coffee makers, engages and pushes a second type of anti-drip-valve to a open position for dripping the brewed coffee from the through hole 210 into the decanter 110.

FIGS. 3A to 3C show a top view a side view and cross sectional side view of a combined lid-assembly 280 when the lid-attachment 200 is mounted onto the base-lid 120. The combined lid assembly 280 is suitable for operation with a second type of coffee makers. The locking fingers 220 are inserted into the slots 150 of the base-lid as the lid-attachment 200 is mounted onto the base-lid 120. After the locking fingers are fully inserted into the slots 150, the lid-attachment is rotated along a direction of the bent hooks 225 such that the bent hooks 225 engage and locked onto the edges of the slots 150 of the base-lid. The lid-attachment can be easily removed by rotating the lid attachment 200 in an opposite direction of the bent hooks 225. The lid-attachment 200 can then be easily removed after the bent hooks 225 are loosened from a locking position. When mounted onto a coffee decanter 110, the combined lid assembly 280 is now suitable for operating with a second type of coffee makers. The combined lid assembly 280 has a greater height suitable for engaging and pushing open a second type of anti-drip valve implemented in a second type of coffee makers.

According to the drawings and above descriptions, this invention discloses a coffee lid-assembly. The coffee lid-assembly 280 includes a base-lid 120 suitable for employing with a first type of coffee makers. The lid-assembly further includes a lid-attachment, e.g., a lid-cap 200, for attaching to the base-lid 120 to constitute a combined lid assembly 280 suitable for employing with a second type of coffee makers. In a preferred embodiment, the base-lid 120 further had receptive adapting means for receiving and removably adapting the lid attachment to the base-lid whereby the lid-attachment may be flexible attached and removed from the base-lid. In another preferred embodiment, the receptive adapting means for receiving and removably adapting the lid attachment further includes several elongated slots 150. And, the lid attachment 200 further comprising fingers 200-1 to 220-3 each having a bent hook 225 for inserting into one of the slots 150 to move along in the slots and hook onto the base-lid. In another preferred embodiment, the base-lid 120 further includes a first drip opening 125 for dripping brewed coffee brewed by the first type of coffee makers therethrough. In another preferred embodiment, the base-lid further includes a first valve opening means 130 for engaging and opening a first-type anti-drip valve of the first type of coffee makers for dripping the brewed coffee through the first drip opening 125. In a preferred embodiment, the lid-attachment 200 further includes a second drip opening 210 for dripping brewed coffee brewed by the second-type of coffee makers therethrough. And, the lid-attachment further includes a second valve opening means 230 for engaging and opening a second-type anti-drip valve of the second type of coffee makers for dripping the brewed coffee through the second drip opening.

This invention further discloses a decanter 110 for operating with at least two types of coffee makers. The decanter further includes a base-lid for mounting on the decanter for brewing coffee with a first type of coffee makers. The decanter further has a lid-attachment for attaching to the base-lid to constitute a combined lid assembly for mounting on and covering the decanter suitable for brewing coffee with a second type of coffee makers. In a preferred embodiment, the base-lid further includes receptive adapting means for receiving and removably adapting the lid attachment to the base-lid whereby the lid-attachment may be flexible attached and removed from the base-lid.

In essence, this invention further discloses a coffee lid-assembly that includes a base-lid suitable for employing with a first type of coffee makers. The base-lid further includes receptive adapting means provided for receiving and removably adapting a lid attachment to constitute a combined lid assembly suitable for employing with a second type of coffee makers. This invention also discloses a lid-attachment 200 to a base-lid 120 for operating a first-type of coffee makers. The lid-attachment includes attachment means 220 for attaching to the base-lid 120 to constitute a combined lid assembly 280 suitable for employing with a second type of coffee makers.

This invention further discloses a method for providing a coffee lid-assembly. The method includes steps of a) providing a base-lid suitable for employing with a first type of coffee makers. The method further includes a step of b) providing a lid-attachment for attaching to the base-lid to constitute a combined lid assembly suitable for employing with a second type of coffee makers. A method for manufacturing a coffee lid-assembly is also disclosed in this invention. The method includes a step of manufacturing a base-lid 120 suitable for employing with a first type of coffee makers. The method further includes a step of manufacturing a lid-attachment 200 for attaching to the base-lid to constitute a combined lid assembly 280 suitable for employing with a second type of coffee makers.

Although the present invention has been described in terms of the presently preferred embodiment, it is to be understood that such disclosure is not to be interpreted as limiting. Various alterations and modifications will no doubt become apparent to those skilled in the art after reading the above disclosure. Accordingly, it is intended that the appended claims be interpreted as covering all alterations and modifications as fall within the true spirit and scope of the invention.

I claim:

1. A coffee lid-assembly comprising:
a base-lid suitable for employing with a first type of coffee makers; and
a lid-attachment for attaching to said base-lid to constitute a combined lid assembly suitable for employing with a second type of coffee makers.

2. The coffee lid-assembly of claim 1 wherein:
said base-lid further comprising receptive adapting means for receiving and removably adapting said lid attachment to said base-lid whereby said lid-attachment may be flexible attached and removed from said base-lid.

3. The coffee lid-assembly of claim 2 wherein:
said receptive adapting means for receiving and removably adapting said lid attachment further comprising several elongated slots and said lid attachment further comprising fingers each having a bent hook for inserting into one of said slots to move along in said slots and hook onto said base-lid.

4. The coffee lid-assembly of claim 1 wherein:
said base-lid further comprising a first drip opening for dripping brewed coffee brewed by said first type of coffee makers therethrough.

5. The coffee lid-assembly of claim 4 wherein:
said base-lid further comprising a first valve opening means for engaging and opening a first-type anti-drip valve of said first type of coffee makers for dripping said brewed coffee through said first drip opening.

6. The coffee lid-assembly of claim 1 wherein:
said lid-attachment further comprising a second drip opening for dripping brewed coffee brewed by said second-type of coffee makers therethrough.

7. The coffee lid-assembly of claim 6 wherein:
said lid-attachment further comprising a second valve opening means for engaging and opening a second-type anti-drip valve of said second type of coffee makers for dripping said brewed coffee through said second drip opening.

8. A decanter for operating with at least two types of coffee makers comprising:
a base-lid for mounting on said decanter for brewing coffee with a first type of coffee makers; and
a lid-attachment for attaching to said base-lid to constitute a combined lid assembly for mounting on and covering said decanter suitable for brewing coffee with a second type of coffee makers.

9. The decanter of claim 8 wherein:
said base-lid further comprising receptive adapting means for receiving and removably adapting said lid attachment to said base-lid whereby said lid-attachment may be flexible attached and removed from said base-lid.

10. The decanter of claim 9 wherein:
said receptive adapting means for receiving and removably adapting said lid attachment further comprising several elongated slots and said lid attachment further comprising fingers each having a bent hook for inserting into one of said slots to move along in said slots and hook onto said base-lid.

11. The decanter of claim 8 wherein:
said base-lid further comprising a first drip opening for dripping brewed coffee brewed by said first type of coffee makers therethrough.

12. The decanter of claim 11 wherein:
said base-lid further comprising a first valve opening means for engaging and opening a first-type anti-drip valve of said first type of coffee makers for dripping said brewed coffee through said first drip opening.

13. The decanter of claim 8 wherein:
said lid-attachment further comprising a second drip opening for dripping brewed coffee brewed by said second-type of coffee makers therethrough.

14. The decanter of claim 13 wherein:
said lid-attachment further comprising a second valve opening means for engaging and opening a second-type anti-drip valve of said second type of coffee makers for dripping said brewed coffee through said second drip opening.

15. A coffee lid-assembly comprising:
a base-lid suitable for employing with a first type of coffee makers wherein said base-lid further comprising receptive adapting means provided for receiving and removably adapting a lid attachment to constitute a combined lid assembly suitable for employing with a second type of coffee makers.

16. The coffee lid-assembly of claim 15 wherein:
said receptive adapting means for receiving and removably adapting said lid attachment comprising several elongated slots disposed on said base-lid ready for receiving said attachment.

17. The coffee lid-assembly of claim 15 wherein:
said base-lid further comprising a first drip opening for dripping brewed coffee brewed by said first type of coffee makers therethrough.

18. The coffee lid-assembly of claim 17 wherein:
said base-lid further comprising a first valve opening means for engaging and opening a first-type anti-drip valve of said first type of coffee makers for dripping said brewed coffee through said first drip opening.

19. A lid-attachment to a base-lid for operating a first-type of coffee makers comprising:
attachment means for attaching to said base-lid to constitute a combined lid assembly suitable for employing with a second type of coffee makers.

20. The lid-attachment of claim 19 wherein:
said lid-attachment further comprising a drip opening for dripping brewed coffee brewed by said second-type of coffee makers therethrough.

21. The lid-attachment of claim 19 wherein:
said lid-attachment further comprising a valve opening means for engaging and opening an anti-drip valve of said second type of coffee makers for dripping said brewed coffee through said drip opening.

22. The lid-attachment of claim 19 wherein:
said attachment means comprising fingers each having a bent hook for inserting into one of several slots on said base-lid to move along in said slots and hook onto said base-lid.

23. A method for providing a coffee lid-assembly comprising:
providing a base-lid suitable for employing with a first type of coffee makers; and
providing a lid-attachment for attaching to said base-lid to constitute a combined lid assembly suitable for employing with a second type of coffee makers.

24. A method for manufacturing a coffee lid-assembly comprising:
manufacturing a base-lid suitable for employing with a first type of coffee makers; and
manufacturing a lid-attachment for attaching to said base-lid to constitute a combined lid assembly suitable for employing with a second type of coffee makers.

25. The method of claim 24 wherein:
said step of manufacturing said base-lid further comprising a step of manufacturing receptive adapting means for receiving and removably adapting said lid attachment to said base-lid whereby said lid-attachment may be flexible attached and removed from said base-lid.

26. The method of claim 25 wherein:
said step of manufacturing said receptive adapting means for receiving and removably adapting said lid attachment further comprising a step of opening several elongated slots on said base-lid and forming on said lid attachment fingers each having a bent hook for inserting into one of said slots to move along in said slots and hook onto said base-lid.
